(19) United States
(12) Patent Application Publication
(10) Pub. No.: US 2004/0018301 A1
(43) Pub. Date: Jan. 29, 2004

(54) Process for improved inorganic polymerization

(76) Inventors: John F. Ackerman, Laramie, WY (US); Andrew J. Skoog, West Chester, OH (US); Matthew B. Buczek, Fairfield, OH (US); Jane Ann Murphy, Franklin, OH (US)

Correspondence Address: Carmen Santa Maria, 100 Pine Street, P.O. Box 1166, Harrisburg, PA, 17108-1166, US

(21) Appl. No.: 10/206,496

(22) Filed: Jul. 26, 2002

(51) Int. Cl. B05D 7/00

(52) U.S. Cl. 427/212

(57) ABSTRACT

A method for the polymerization of metal oxo-hydroxide in solution to form dense contiguous oxide films on small particles suspended in the solution. A standard ethanol-based sol-gel reaction solution is prepared by resulting in a solution containing dissolved metal oxo-hydroxides and phosphates, as well as finely divided suspended metal substrate particles. Intermediate molecular weight alcohols, namely alcohols with three, four, five, six or seven carbon atoms, are added to the reaction solution to increase the boiling point of the reaction. The temperature of the reaction solution is raised to below the boiling point of the solution. Water is added to the reaction solution to initiate the polymerization of the metal oxo-hydroxide. The polymerization reaction, coupled with the phosphates acting a surfactant, coats the metal substrate particles with a dense contiguous coating of metal oxide.

### FIELD OF THE INVENTION

The present invention is directed to a process for improved inorganic polymerizations to form dense contiguous oxide films and coatings.

### BACKGROUND OF THE INVENTION

In a number of applications in which small metal oxide coated particles are required, it is necessary to coat metal substrate particles with metal oxides in a manner in which the coatings have certain mechanical and optical properties. In these applications, the metal oxide coating may be applied to the metallic particles to protect the particles from deterioration due to exposure to the atmosphere. In other applications, the metal oxide coated particles can be added to a paint as a pigment. A liquid phase polymerization (LPP) process can be used to apply such coatings to the particles. In one form of this process, metal substrate particles can be suspended in an alcohol-based solution containing metal oxo-hydroxides. The temperature of the solution is increased and water is added to the solution to catalyze the polymerization of the metal oxo-hydroxides. This polymerization reaction coats the surface of the metal substrate particles with metal oxide. The coated particles can then be fired. Many solution coating techniques rely on the polymerization of metal oxo-hydroxide species to form metal oxide suspensions which can coat substrates with low density oxides. Such polymerization reactions form the basis for LUDOX®, and sol-gel coatings.

When solutions are used to coat the substrate, the initial solution may contain, for example, ethanol (EtOH) as the primary solvent, phosphates which function as surfactants and high temperature binders, and metal oxo-hydroxides, which are the precursor to the metal oxide coating. Other precursors include metal salts and alkoxides.

To further elaborate on the preceding example, there are two common types of sol-gel solutions that can be used to form coated substrates, a gelatinous solution with a low EtOH content, and a liquid solution with a higher EtOH content. The nature of the solution, whether liquid or gelatinous is determined by the EtOH content of the solution. A gelatinous solution is created when the alcohol content is about 30% to about 40% alcohol by volume. If the alcohol content of the solution is greater than about 40% alcohol by volume, the solution will be a homogeneous liquid. The exact concentration of the components of the solution is dependent on the required thickness of the metal oxide coating on the surface of the metal substrate particles. The thicker the required metal oxide layer, the higher the concentration of metal oxo-hydroxide species in the reaction solution. Generally, the metal oxo-hydroxide species include up to about 40% of the reaction solution by volume and phosphates, which act as a surfactant and high temperature binder between the metal substrate particles and the metal oxide species, occupy up to about 15% of the solution by volume.

The LPP solutions are most useful in coating small metal substrates that are suspended in the solution, while the gelatinous form of such solutions are useful for applying a continuous, low density coating on larger substrates. The present invention is based on a liquid phase polymerization solution that avoids gelation by controlling the appropriate polymerization reaction.

Once a liquid EtOH-based reaction solution is prepared, the temperature of the reaction solution is raised to a temperature below the boiling point of the reaction solution and water is slowly added to the solution. As water is added to the reaction solution, the metal oxo-hydroxide begins to form, silica-phosphates on the metal substrate from the metal oxo-hydroxide precursor. This coats the substrate particles that are suspended in the solution. The phosphates in the reaction solution activate the surface of the metal substrate particles, which allows the metal oxide to coat the surface of the metal substrate particles. If the water is added to the reaction solution too rapidly, the metal oxide will begin to form more quickly. In this situation, the metal oxide will begin to form a continuous network which will cause liquid solution to become a gel or to precipitate pure metal oxide particles without coating the particles. The result will be undesirable suspended metallic particles in a continuous gel or in solution.

The polymerization of metal oxo-hydroxides in a LPP reaction solution to form dense contiguous oxide films and coatings must proceed slowly because the polymerization reaction has temperature limits imposed by the boiling points of the various constituents. The primary constituent, EtOH, has a low boiling point, which determines the temperature limits. The higher the boiling point of the polymerization solution, the higher the temperature at which the reaction can be run. Running the reaction at a higher temperature typically increases the reaction rate of the polymerization reaction. However, the polymerization reaction cannot be run at or above the boiling point of the solution, since rapid evaporation of the EtOH at the boiling point of the solution causes a rapid agglomeration of the metal oxide, resulting in unusable coated substrates. In an EtOH based reaction solution, the polymerization reaction can occur at a maximum temperature of 72° C. (160° F.) and must be run for a period of 3 days at 72° C. in order to properly coat the metal substrate particles.

Theoretically, the boiling point of the LPP solution could be increased by changing the solvent from EtOH to a solvent with a higher boiling point. Changing solvents can have other effects on the polymerization reaction. For example, acidic or basic solvents can adversely affect the rate of the reaction and polymerization. Solvents of the improper hydrophobicity can induce phase separation leading to either rapid precipitation of material or no reaction. Aqueous solutions can lead to rapid homogeneous nucleation of the metal oxide.

Attempts in the past to improve the quality and speed of the polymerization process, which results in increasing the rate of the coating of the substrate, have centered on increasing the concentration of the precursors of the metal oxo-hydroxide species in the reaction solution through the evaporation of alcohol in the reaction solution. As the EtOH evaporates, the rheological properties of the solution are altered. The metal oxide forms as clumps which may or may not stick to the metal substrate particles. In any event, a smooth, uniform continuous layer does not form on the metal particle. If too much EtOH is allowed to evaporate prior to the polymerization reaction, a poor quality coating on the substrate will be produced. Additionally, increasing the concentration of the metal oxy-hydroxide precursors causes homogenous nucleation of the metal substrates particles to occur, which results in unusable coated substrates. No techniques currently known in the art utilize the addition of a suitable high boiling point solvent after the initial formation of the metal oxo-hydroxide species to permit the polymerization reaction to occur at an elevated temperature. Such an increase in the reaction temperature should improve both the rate of reaction and the quality of the coating on the substrate.

What is desirable is the addition of solvent that raises the boiling point of the reaction solutions but does not interfere with the sensitive chemistry of the polymerization reaction and coating process.

### SUMMARY OF THE INVENTION

The present invention is an improvement to a LPP process that coats substrate particles in-situ with homogenous metal oxide coatings by an inorganic polymerization process. A LPP reaction solution is prepared in a non-reactive container, such as glass or stainless steel, as is known in the art. The reaction solution contains dissolved phosphates and metal oxo-hydroxides, in an EtOH solution, and small metal substrate particles that are suspended in the reaction solution. The metal substrate particles are sufficiently small so that the particles are suspended in the solution when the solution is stirred, but do not precipitate out of the solution. Alcohols with three (C3) to seven (C7) carbon atoms are then added to the solution to raise its boiling point. The C3 to C7 alcohols are added until alcohols comprise about 75% of the solution by weight. The added alcohols may be a mixture of the C3 to C7 alcohols or may be solely comprised of one alcohol selected from the group of C3 to C7 alcohols; however they are selected and mixed to achieve a predetermined boiling point. The temperature of the reaction solution is then raised to a point just below its boiling point. Once the temperature of the solution is raised to just below its boiling point, water is slowly added, thereby causing a polymerization of metal oxo-hydroxide species, such as, for example poly-silicon oxide hydroxide. The polymerization reaction causes a layer of metal oxide to deposit on the metal particle surfaces, with the phosphates in the solution acting as a surfactant and a binder to facilitate such deposition. The rate of the coating deposition depends on the rate of the polymerization reaction, which is dependent on the temperature at which the reaction is run and the rate at which water is added. The present invention allows an oxo-hydroxide polymerization reaction to be run a higher temperature that is currently known in the art. This increase in reaction temperature allows the rapid coating of metal substrate particles with a metal oxide coating, which results in a coating with improved chemical and mechanical properties. Surprisingly, the reaction temperature provides not only a faster rate of deposition of the metal oxide, but also a denser metal oxide coating than is attainable using EtOH.

An advantage of the present invention is that a metal oxide coating can be deposited onto the surfaces of finely divided metallic particles much faster using the process of the present invention.

Another advantage of the present invention is that the boiling temperature of the solution can be varied continuously as desired within limits between the boiling point of ethanol and the boiling point of the highest molecular weight alcohol added to the solution.

Yet another advantage of the present invention is that a more dense metal oxide coating can be applied than heretofore could be applied using ethanol solutions. In addition, by controlling the solution temperature between the boiling point of ethanol and the boiling point of the highest molecular weight alcohol, the thickness of the deposited metal oxide can be precisely controlled.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a flow chart illustrating the method steps of coating of small metal substrate particles with a dense contiguous oxide film.

### DETAILED DESCRIPTION OF THE INVENTION

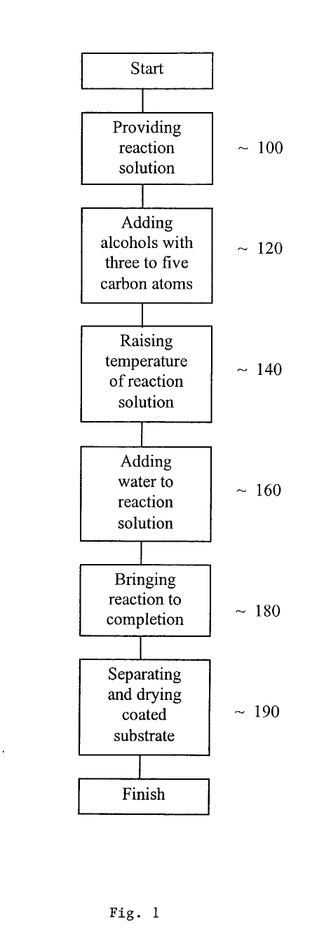

As shown in FIG. 1., the first step of the present invention is the preparation, preferably in a closed non-reactive vessel with a condensation retort, of a reaction solution 100, known to the art, comprising phosphates and metal oxo-hydroxides, both of which are dissolved in EtOH, and small metal substrate particles suspended in the EtOH solution. Once the solution is prepared, intermediate molecular weight alcohols, namely alcohols with three to seven carbon atoms, and preferably three to five carbon atoms, are added to the solution so that the alcohols comprise more than about 40%, but less than about 90% of reaction solution by volume 120. The temperature of the reaction solution is then raised to just below the boiling point of the solution 140. Once the temperature is raised, water is slowly and precisely metered to the reaction solution to polymerize the metal oxo-hydroxide species at a rate that avoids forming a gel 160. This polymerization reaction initiated by the addition of water, coupled with the surfactant properties of the phosphates in the solution causes a dense contiguous metal oxide coating to form on the surface of the metal substrates that are suspended in the metal oxo-hydroxide solution, but without the formation of a gel within the solution. If the rate of water addition is too high, precipitates begin to form in the solution and gelation occurs. The water is continuously added at a constant rate and the reaction solution is maintained at a temperature just below the boiling point of the solution as the reaction is allowed to run to completion 180. The reaction solution is continuously stirred to keep the metallic particles in suspension. The suspended metal particles, which are now coated with a dense contiguous metal oxide coating are separated from solution via vacuum filtration and dried as known in the art 190.

The rate of reaction and quality of coating are improved by the present invention through the addition of C3 to C7 alcohols, until the total alcohol content comprises about 75% by volume of the reaction solution. The addition of such intermediate molecular weight alcohols can raise the boiling point of the reaction solution about 25° F. higher than the boiling point of the prior art EtOH reaction solution. By using C3 to C7 alcohols, rather than other solvents, to raise the boiling point, both two-phase precipitation and adverse chemical reactions are avoided. The boiling point of the solution can be adjusted by adjusting the percentages of the higher molecular weight alcohols to achieve the desired boiling point.

The metal substrate particles that may be coated using the present invention include iron, cobalt, nickel, copper, and combinations thereof, and alloys of iron, aluminum, copper, nickel, cobalt, vanadium, chromium, zirconium, and combinations thereof. The size of the metal substrate particles that may be used depend on the density of the metal or metal alloy, as the size, aspect ratios, and density of the particles will determine whether such particles can be suspended in a reaction solution. Typically, for example, iron-aluminum spheres having a diameter in the range of 10-20μ can be coated using the process of the present invention.

The metal oxides that may be used to coat the metal substrate particles included silicon dioxide, titanium oxide, germanium oxide, and tin oxide and combinations thereof. In order to produce the proper oxide coating, the proper oxo-hydroxide must be used. For example, to obtain a silicon oxide coating, tetra-ethyl-orthosilicate (TEOS) must be added to the reaction solution.

Various mixtures, isomers, and amounts of C3 to C7 alcohols, and preferably, C3, C4, and C5 alcohols may be used with the present invention. However, the total amount of alcohol in the reaction solution should not exceed 75% of the solution by volume. While the differing mixtures and amounts necessarily mean that the reaction must be run at different temperatures and for different lengths of time, all embodiments of the present invention can be run a higher temperatures and for shorter lengths of time than the prior art EtOH reaction solution. The specific selection of mixtures is determined by the preselected temperature at which to run the reaction.

Higher molecular weight alcohols, such as hexanol cannot be used in the reaction solution. It was discovered that when a higher molecular weight alcohol, n-octanol (C8), was added to a silicon oxo-hydroxide solution, a two-phase separation occurred at 70° C. which caused an immediate precipitation of a hydrous mass. Thus, simply increasing the molecular weight of the alcohol is not an effective way to achieve a higher reaction temperature. The precipitation of the hydrous mass prevented the proper coating of the metal substrate particles, so that C-8 alcohols and higher cannot be substituted.

The increase in the polymerization rate of the metal oxo-hydroxide has a number of benefits, including increasing the density of the metal oxide coating, decreasing the porosity of the metal oxide coating, and increasing the contiguity of the metal oxide coating. The denser coating is formed because of an increase in the rate of precipitation at higher temperatures, which provides an improved microstructure. Other advantages of the metal oxide coating created using the present invention include better separation and drying of the coated substrate particles, higher dielectric constant of the coating, better microscopic uniformity of the coating, less homogenous nucleation of oxide, superior optical properties of the coating, improved thermal stability due to a denser coating, and improved chemical stability when the substrate is used in severe environmental conditions. Ideally, the starting point of the reaction is at the stoichiometric ratio of water to TEOS, 4:1. The stoichiometric ratio can be exceeded by adding water at a rate sufficient to provide an excess of water to carry out the reaction, as the solution can tolerate some excess water. However, the rate of water addition should not be sufficiently high so as to form a gel. If water is added at a rate that provides a rate that is less than the stoichiometric ratio, the reaction will be slowed down and the coating thickness deposited in a unit of time will decrease.

### EXAMPLE 1

In one embodiment of the present invention, an initial silicon oxo-hydroxide reaction solution dissolved in ethanol was prepared by techniques known to the art. The solution originally included about 200 ml. of tetraethyl phosphate (TEP) and 180 ml of tetraethyl orthosilicate (TEOS). The volume of the solution was increased through the addition of n-propanol to the ethanol, of a sufficient quantity so that the n-propanol comprised about 50% by volume of the solution, which raised the reaction temperature of about 82° C. The temperature of the reaction solution was raised to 86° C. by the addition of 900 ml. more of n-propanol so that it comprised 74.3% of the solution by volume, TEOS about 12.2% by volume and TEP about 13.5% by volume. Water was added to the reaction solution as known in the art. The polymerization reaction was completed in 1 day. This is a significant reduction from the 2.5 to 3 days required to complete the polymerization reaction when using a EtOH-based solution. The result of the reaction was the coating of metal substrate particles with a dense contiguous layer of silicon dioxide (SiO₂).

### EXAMPLE 2

In a second embodiment of the present invention, an initial silicon oxo-hydroxide reaction solution was prepared by techniques known to the art. The volume of the solution was increased through the addition of t-butanol, of a sufficient quantity so that alcohol comprised 40% of the reaction solution by volume The temperature of the reaction solution was raised to 92° C. and water was added to the reaction solution as known in the art. The polymerization reaction was completed in 1 day. The result of the reaction was the coating of metal substrate particles with a dense contiguous layer of SiO₂.

Coatings of SiO₂, SiO₂-titanium dioxide, and SiO₂-phosphate can be generated using various precursors, including silicon precursors of silicon acetate. Other precursors include hydrolyzed titanium alkoxide, titanium chloride, aluminum isopropoxide, aluminum and aluminum isopropxide, aluminum chloride and water, germanium oxide, and tin oxide. The heterogeneous reaction of the present invention is effective, as water and oxo-hydroxide produce metal oxide on the particle surface when surfactants are present and the rate of water addition is carefully controlled.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for the polymerization of metallic precursors in solution to form dense contiguous metal oxide films on substrate particles comprising the steps of:
providing a reaction solution comprising ethanol, phosphates, and metallic precursors;
adding metal substrate particles that are suspended in the reaction solution;
adding alcohols having three to seven carbon atoms to the reaction solution to raise the boiling point of the solution above the boiling point of ethanol, until the total alcohol content in the solution comprises up to about 75% of the reaction solution by weight;
increasing the temperature of the reaction solution to a temperature below the boiling point of the reaction solution;
adding water to the reaction solution, at a rate sufficient to polymerize the metallic precursors while avoiding the formation of a gel to deposit a contiguous metal oxide layer on surfaces of the suspended substrate particles; and
continuing to add water at a constant rate while sustaining the temperature of the reaction of the reaction solution at a temperature above the boiling point of ethanol and below the boiling point of the reaction solution until the polymerization of the metallic precursors is complete, thereby increasing the rate at which metal oxide coating is deposited on the surfaces of the metal particles.

2. The method of polymerization of claim 1 further including the additional step of stirring the solution while adding water to maintain the metal substrate particles in suspension.

3. The method of claim 1 wherein the step of adding alcohols to the reaction solution includes adding alcohols having three to five carbon atoms.

4. The method of claim 1 wherein the metallic precursors include at least one precursor selected from the group consisting of silicon precursors of silicon acetate, hydrolyzed titanium alkoxide, titanium chloride, aluminum isopropoxide, aluminum plus aluminum isopropoxide, aluminum chloride plus water, germanium oxide, and tin oxide.

5. The method of claim 1 wherein the metallic precursors are metal oxo-hydroxides.

6. A method for the polymerization of metal oxo-hydroxide in solution to form dense contiguous metal oxide films on finely divided metal substrate particles comprising the steps of:
providing an initial reaction solution comprising an alcohol, phosphates, and metal oxo-hydroxides;
adding finely divided metal substrate particles that are suspended in the reaction solution;
adding alcohols having three to seven carbon atoms to the reaction solution to raise the boiling point of the solution above the boiling point of ethanol, until the total alcohol content in the solution comprises between about 40% to about 90% of the reaction solution by volume;
increasing the temperature of the reaction solution to a temperature below the boiling point of the reaction solution;
adding water to the reaction solution, at a rate sufficient to polymerize the metal oxo-hydroxide while avoiding the formation of a gel to deposit a contiguous metal oxide layer on surfaces of the suspended substrate particles; and
continuing to add water at a constant rate while sustaining the temperature of the reaction of the reaction solution at a temperature above the boiling point of ethanol and below the boiling point of the reaction solution until the polymerization of the metal oxo-hydroxide species is complete, thereby increasing the rate at which metal oxide coating is deposited on the surfaces of the metal particles.

7. The method of claim 6 wherein the alcohol in the initial reaction solution is selected from the group consisting of alcohols having from 2 to 7 carbon atoms.

8. The method of claim 6 wherein the total alcohol content of the reaction solution after addition of alcohols having three to seven carbon atoms to the reaction solution is between about 70-80% by volume alcohol.

9. The method of claim 8 wherein the total alcohol content of the reaction solution after addition of alcohols having three to seven carbon atoms to the reaction solution is about 75% by volume alcohol.

10. The method of claim 6 wherein sufficient alcohol having three to seven carbon atoms is added to the reaction solution to raise the boiling point of the reaction solution at least about 25° F. higher than the boiling point of ethanol.

11. The method of claim 6 wherein the step of adding metal substrate particles includes adding particles selected from the group consisting of iron, aluminum, nickel, cobalt and combinations thereof.

12. The method of claim 6 wherein the step of adding metal substrate particles includes adding particles comprised of alloys of at least two elements selected from the group consisting of iron, aluminum, copper, nickel, cobalt, vanadium, chromium, zirconium and combinations thereof.

13. The method of claim 6 wherein the finely divided metal particles have at least one dimension with a size of about 10-20 microns.

14. The method of claim 12 wherein the step of adding metal substrate particles includes adding spherical iron-aluminum particles having a diameter in the range of about 10-20 microns.

15. The method of claim 6 wherein the step of providing a reaction solution includes providing a reaction solution that includes metal oxo-hydroxides that polymerize to deposit an oxide selected from the group consisting of titanium oxide, silicon oxide, tin oxide, germanium oxide and combinations thereof on the surface of the suspended particles.

16. A method for the polymerization of silicon oxo-hydroxide in solution to form dense contiguous metal oxide films on finely divided metal substrate particles comprising the steps of:
providing an initial reaction solution comprising about 200 ml. of tetraethyl phosphate and 180 ml of tetraethyl orthosilicate dissolved in ethanol;
adding finely divided metal substrate particles that are suspended in the reaction solution;
adding n-propanol to the reaction solution to raise the boiling point of the solution to about 86° C.;
increasing the temperature of the reaction solution to a temperature just below the boiling point of the reaction solution;
adding water to the reaction solution, at a rate sufficient to polymerize the tetraethyl orthosilicate to initiate deposition of a contiguous silicon dioxide layer on surfaces of the suspended substrate particles; and
continuing to add water at a constant rate over a preselected period of time while sustaining the temperature of the reaction of the reaction solution below its boiling point until the polymerization of the tetraethyl orthosilicate is complete.

17. The method of claim 16 wherein the preselected period of time is one day.

18. The method of claim 16 wherein the step of adding water to the reaction solution includes adding water in an amount between below the stoichiometric ratio of water to tetraethyl orthosilicate, about 4:1, to just below the amount of water which causes gelation of the reaction solution.

19. A method for the polymerization of silicon oxo-hydroxide in solution to form dense contiguous metal oxide films on finely divided metal substrate particles comprising the steps of:
providing an initial reaction solution comprising tetraethyl phosphate and tetraethyl orthosilicate dissolved in ethanol;
adding finely divided metal substrate particles that are suspended in the reaction solution;
adding n-butanol to the reaction solution to raise the boiling point of the solution to about 92° C.;
increasing the temperature of the reaction solution to a temperature just below the boiling point of the reaction solution;
adding water to the reaction solution, at a rate sufficient to polymerize the tetraethyl orthosilicate to initiate deposition of a contiguous silicon dioxide layer on surfaces of the suspended substrate particles; and
continuing to add water at a constant rate over a preselected period of time while sustaining the temperature of the reaction of the reaction solution below its boiling point until the polymerization of the tetraethyl orthosilicate is complete.

20. The method of claim 19 wherein the step of adding n-butanol includes adding n-butanol to raise the total alcohol content of the reaction solution to about 40% by volume.
